(19) United States
(12) Patent Application Publication
(10) Pub. No.: US 2022/0369288 A1
(43) Pub. Date: Nov. 17, 2022

(54) INTER USER EQUIPMENT COORDINATION FOR RESOURCE POOLS

(71) Applicant: QUALCOMM Incorporated, San Diego, CA (US)

(72) Inventors: Seyedkianoush HOSSEINI, San Diego, CA (US); Gabi SARKIS, San Diego, CA (US); Tien Viet NGUYEN, Bridgewater, NJ (US); Sourjya DUTTA, San Diego, CA (US)

(21) Appl. No.: 17/662,831

(22) Filed: May 10, 2022

Related U.S. Application Data
(60) Provisional application No. 63/187,338, filed on May 11, 2021.

(51) Int. Cl. H04W 72/02; H04W 28/26; H04W 72/12

(52) U.S. Cl. CPC H04W 72/02; H04W 28/26; H04W 72/1263

(57) ABSTRACT

Various aspects of the present disclosure generally relate to wireless communication. In some aspects, a first user equipment (UE) may select, from stored configuration information or a received indication, an inter-UE coordination scheme that is configured for a resource pool associated with the first UE. The UE may transmit, to a second UE, an indication of one or more of preferred sidelink resources or non-preferred sidelink resources for transmission from the second UE to the first UE, based at least in part on the inter-UE coordination scheme. Numerous other aspects are described.

### CROSS-REFERENCE TO RELATED APPLICATION

This Patent Application claims priority to U.S. Provisional Patent Application No. 63/187,338, filed on May 11, 2021, entitled “INTER USER EQUIPMENT COORDINATION FOR RESOURCE POOLS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for inter user equipment coordination for resource pools.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a first user equipment (UE) includes selecting, from stored configuration information or a received indication, an inter-UE coordination scheme that is configured for a resource pool associated with the first UE. The method may also include transmitting, to a second UE, an indication of one or more of preferred sidelink resources or non-preferred sidelink resources for transmission from the second UE to the first UE, based at least in part on the inter-UE coordination scheme.

In some aspects, a method of wireless communication performed by a first UE includes receiving, from a second UE according to an inter-UE coordination scheme configured for a resource pool associated with the first UE, an indication of one or more of preferred sidelink resources or non-preferred sidelink resources for transmission to the second UE. The method may also include sensing sidelink resources if the inter-UE coordination scheme specifies that the first UE is to perform sensing, and transmitting a communication on a sidelink channel to the second UE based at least in part on the indication of the one or more of preferred sidelink resources or non-preferred sidelink resources and a result of the sensing if sensing is performed.

In some aspects, a first UE for wireless communication includes a memory and one or more processors coupled to the memory and configured to select, from stored configuration information or a received indication, an inter-UE coordination scheme that is configured for a resource pool associated with the first UE, and transmit, to a second UE, an indication of one or more of preferred sidelink resources or non-preferred sidelink resources for transmission from the second UE to the first UE, based at least in part on the inter-UE coordination scheme.

In some aspects, a UE for wireless communication includes a memory and one or more processors coupled to the memory and configured to receive, from a second UE according to an inter-UE coordination scheme configured for a resource pool associated with the first UE, an indication of one or more of preferred sidelink resources or non-preferred sidelink resources for transmission to the second UE, sense sidelink resources if the inter-UE coordination scheme specifies that the first UE is to perform sensing, and transmit a communication on a sidelink channel to the second UE based at least in part on the indication of the one or more of preferred sidelink resources or non-preferred sidelink resources and a result of the sensing if sensing is performed.

In some aspects, a non-transitory computer-readable medium storing a set of instructions includes one or more instructions that, when executed by one or more processors of a first UE, cause the first UE to select, from stored configuration information or a received indication, an inter-UE coordination scheme that is configured for a resource pool associated with the first UE, and transmit, to a second UE, an indication of one or more of preferred sidelink resources or non-preferred sidelink resources for transmission from the second UE to the first UE, based at least in part on the inter-UE coordination scheme.

In some aspects, a non-transitory computer-readable medium storing a set of instructions includes one or more instructions that, when executed by one or more processors of a first UE, cause the first UE to receive, from a second UE according to an inter-UE coordination scheme configured for a resource pool associated with the first UE, an indication of one or more of preferred sidelink resources or non-preferred sidelink resources for transmission to the second UE, sense sidelink resources if the inter-UE coordination scheme specifies that the first UE is to perform sensing, and transmit a communication on a sidelink channel to the second UE based at least in part on the indication of the one or more of preferred sidelink resources or non-preferred sidelink resources and a result of the sensing if sensing is performed.

In some aspects, an apparatus includes means for selecting, from stored configuration information or a received indication, an inter-UE coordination scheme that is configured for a resource pool associated with the apparatus, and means for transmitting, to another apparatus, an indication of one or more of preferred sidelink resources or non-preferred sidelink resources for transmission from the other apparatus to the apparatus, based at least in part on the inter-UE coordination scheme.

In some aspects, an apparatus includes means for receiving, from another apparatus according to an inter-UE coordination scheme configured for a resource pool associated with the apparatus, an indication of one or more of preferred sidelink resources or non-preferred sidelink resources for transmission to the other apparatus, means for sensing sidelink resources if the inter-UE coordination scheme specifies that the apparatus is to perform sensing, and means for transmitting a communication on a sidelink channel to the other apparatus based at least in part on the indication of the one or more of preferred sidelink resources or non-preferred sidelink resources and a result of the sensing if sensing is performed.

Aspects generally include a method, apparatus, system, computer program product, non-transitory computer-readable medium, user equipment, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of selecting sidelink resources, in accordance with the present disclosure.

FIG. 5 is a diagram illustrating an example of using a resource report for sidelink resources, in accordance with the present disclosure.

FIG. 6 is a diagram illustrating an example of indicating and using scheduled sidelink resources, in accordance with the present disclosure.

FIG. 7 is a diagram illustrating an example of indicating and using sidelink resources, in accordance with the present disclosure.

FIG. 8 is a diagram illustrating an example process performed, for example, by a first UE, in accordance with the present disclosure.

FIG. 9 is a diagram illustrating an example process performed, for example, by a first UE, in accordance with the present disclosure.

FIGS. 10-11 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

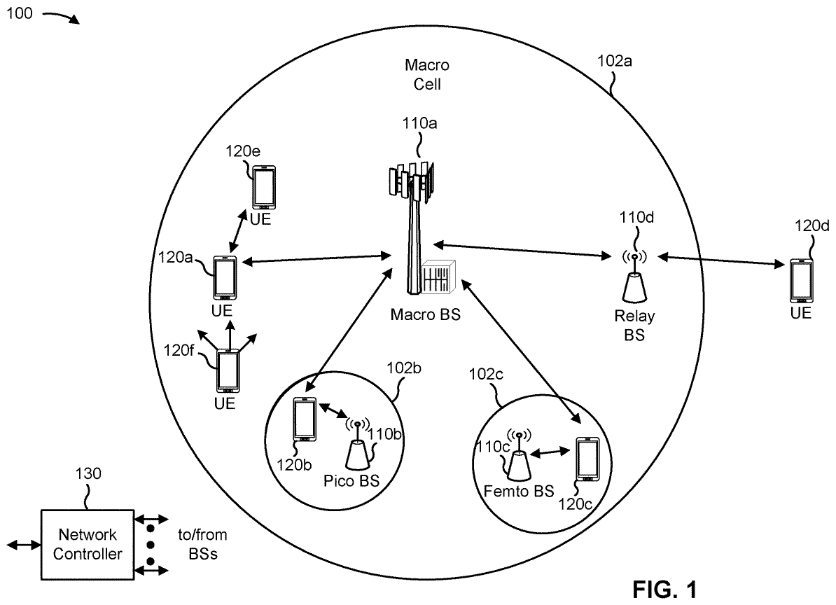

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. A wireless node may provide, for example, connectivity for or to a network (e.g., a wide area network such as Internet or a cellular network) via a wired or wireless communication link. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “sub-6 GHz” band. A similar nomenclature issue sometimes occurs with regard to FR2, which is often referred to (interchangeably) as a “millimeter wave” band, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may select, from stored configuration information or a received indication, an inter-UE coordination scheme that is configured for a resource pool associated with the first UE, and transmit, to a second UE, an indication of one or more of preferred sidelink resources or non-preferred sidelink resources for transmission from the second UE to the first UE, based at least in part on the inter-UE coordination scheme.

In some aspects, the communication manager 140 may receive, from a second UE according to an inter-UE coordination scheme configured for a resource pool associated with the first UE, an indication of one or more of preferred sidelink resources or non-preferred sidelink resources for transmission to the second UE, sense sidelink resources if the inter-UE coordination scheme specifies that the first UE is to perform sensing, and transmit a communication on a sidelink channel to the second UE based at least in part on the indication of the one or more of preferred sidelink resources or non-preferred sidelink resources and a result of the sensing if sensing is performed. Additionally, or alternatively, the communication manager 140 may perform one or more other operations described herein.

As indicated above, FIG. 1 is provided as an example. Other examples may differ from what is described with regard to FIG. 1.

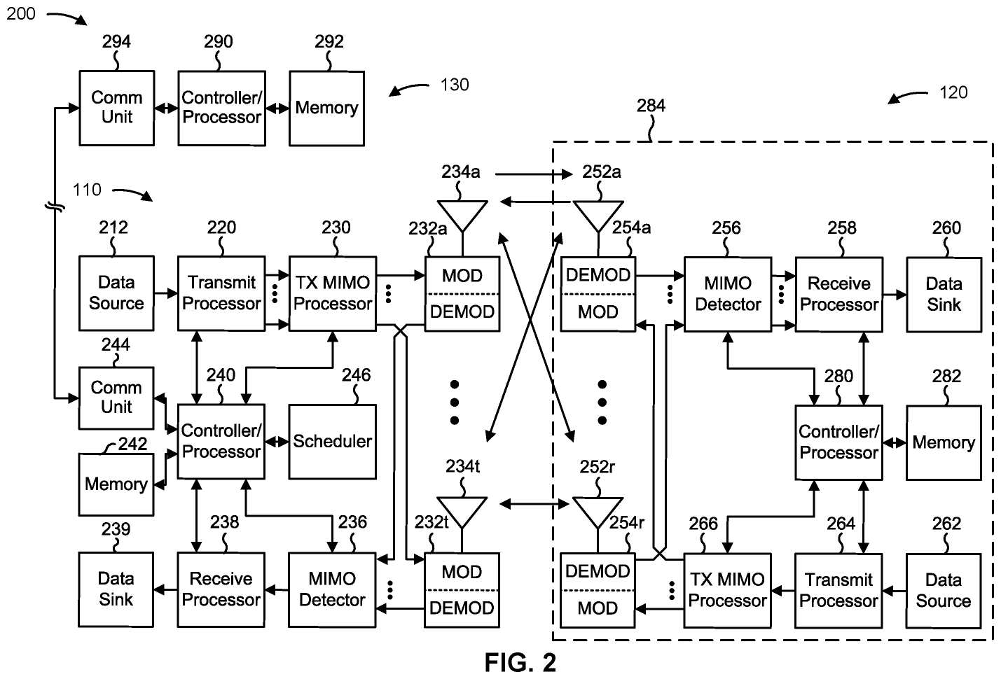

FIG. 2 is a diagram illustrating an example 200 of a base station 110 in communication with a UE 120 in a wireless network 100, in accordance with the present disclosure. The base station 110 may be equipped with T antennas 234a through 234t, and UE 120 may be equipped with R antennas 252a through 252r, where in general T≥1 and R≥1.

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM) and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 1-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 1-11).

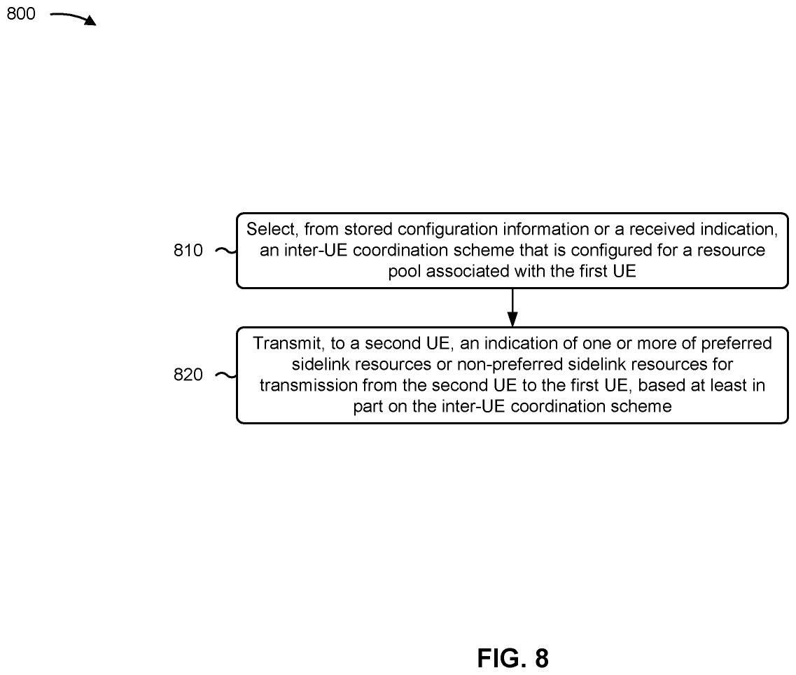

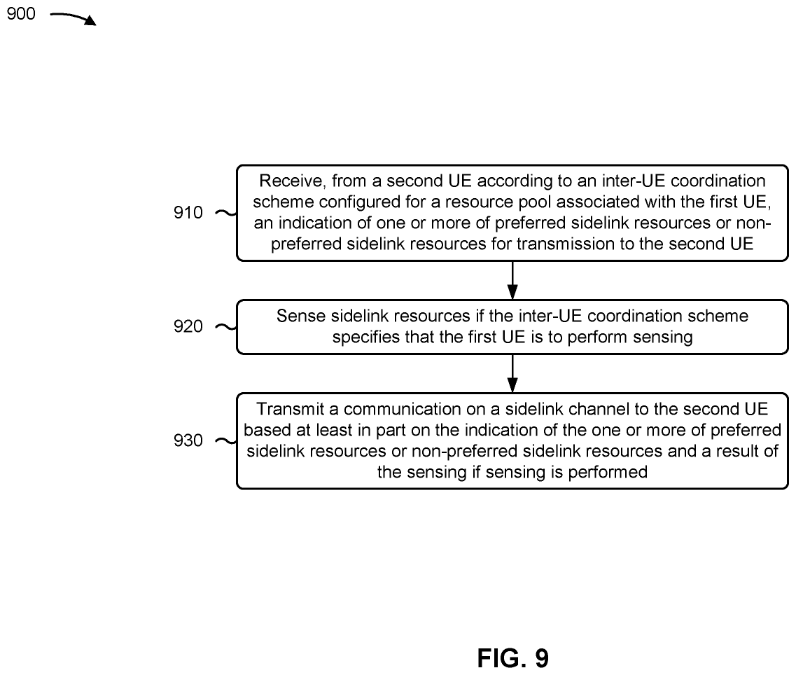

The controller/processor 240 of the base station 110, the controller/processor 280 of the UE 120, and/or any other component(s) of FIG. 2 may perform one or more techniques associated with inter-UE coordination for resource pools, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a first UE (e.g., UE 120) includes means for selecting, from stored configuration information or a received indication, an inter-UE coordination scheme that is configured for a resource pool associated with the first UE, and/or means for transmitting, to a second UE, an indication of one or more of preferred sidelink resources or non-preferred sidelink resources for transmission from the second UE to the first UE, based at least in part on the inter-UE coordination scheme. The means for the first UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a first UE (e.g., UE 120) includes means for receiving, from a second UE according to an inter-UE coordination scheme configured for a resource pool associated with the first UE, an indication of one or more of preferred sidelink resources or non-preferred sidelink resources for transmission to the second UE, means for sensing sidelink resources if the inter-UE coordination scheme specifies that the first UE is to perform sensing, and/or means for transmitting a communication on a sidelink channel to the second UE based at least in part on the indication of the one or more of preferred sidelink resources or non-preferred sidelink resources and a result of the sensing if sensing is performed. The means for the first UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

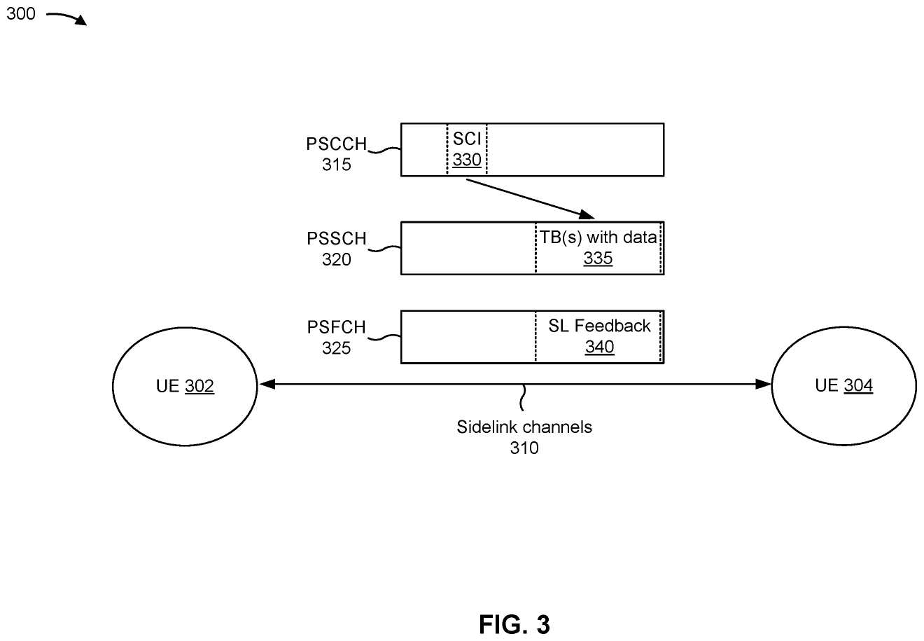

FIG. 3 is a diagram illustrating an example 300 of sidelink communications, in accordance with the present disclosure.

As shown in FIG. 3, a first UE 302 may communicate with a second UE 304 (and one or more other UEs) via one or more sidelink channels 310. UE 302 and UE 304 may communicate using the one or more sidelink channels 310 for P2P communications, D2D communications, V2X communications (e.g., which may include V2V communications, V2I communications, and/or V2P communications) and/or mesh networking. In some aspects, UE 302 and UE 304 may correspond to one or more other UEs. In some aspects, the one or more sidelink channels 310 may use a PC5 interface and/or may operate in a high frequency band (e.g., the 5.9 gigahertz (GHz) band). Additionally, or alternatively, UE 302 and UE 304 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station (e.g., base station 110) via an access link or an access channel. The PSSCH 320 may be used to communicate data, similar to a physical downlink shared channel (PDSCH) and/or a physical uplink shared channel (PUSCH) used for cellular communications with a base station via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARD) feedback (e.g., acknowledgement or negative acknowledgement (ACK/NACK) information), transmit power control (TPC), and/or a scheduling request (SR).

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, UE 304 may operate using a transmission mode where resource selection and/or scheduling is performed by UE 302 (e.g., rather than a base station). In some aspects, UE 302 and/or UE 304 may perform resource selection and/or scheduling by sensing channel availability for transmissions. For example, UE 304 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, may measure an RSRQ parameter (e.g., a PSSCH-RSRQ parameter) associated with various sidelink channels, and/or may determine a signal-to-interference ratio (SIR) associated with another UE on a sidelink channel. UE 304 may select a channel for transmission of a sidelink communication based at least in part on the measurement(s).

Additionally, or alternatively, UE 304 may perform resource selection and/or scheduling using SCI 330 received in the PSCCH 315, which may indicate occupied resources and/or channel parameters. Additionally, or alternatively, UE 304 may perform resource selection and/or scheduling by determining a channel busy ratio (CBR) associated with various sidelink channels, which may be used for rate control (e.g., by indicating a maximum number of resource blocks that UE 304 can use for a particular set of subframes).

In the transmission mode where resource selection and/or scheduling is performed by UE 302, UE 302 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, UE 302 may generate a sidelink grant that indicates one or more parameters for semi-persistent scheduling (SPS), such as a periodicity of a sidelink transmission. Additionally, or alternatively, UE 302 may generate a sidelink grant for event-driven scheduling, such as for an on-demand sidelink message.

UE 302 and UE 304 may operate in sidelink resource allocation Mode 2, in which UE 302 and UE 304 schedule or reserve their own sidelink resources without the assistance or direction of a base station (Mode 1). In some aspects, UE 302 may indicate available sidelink resources to UE 304, and UE 304 may select a sidelink resource for transmission from these available sidelink resources. UE 304 may also sense one or more of the sidelink channels 310 to determine which sidelink resources are available. UE 304 may select a sidelink resource for transmission from the sidelink resources that UE 302 indicates as available and/or from the sidelink resources that UE 304 senses are available. In some aspects, UE 302 may schedule one or more preferred sidelink resources on behalf of UE 304. According to various aspects described herein, UE 120a may indicate available sidelink resources and/or schedule sidelink resources based at least in part on overhearing availability reports that are broadcast from other UEs.

As indicated above, FIG. 3 is provided as an example. Other examples may differ from what is described with regard to FIG. 3.

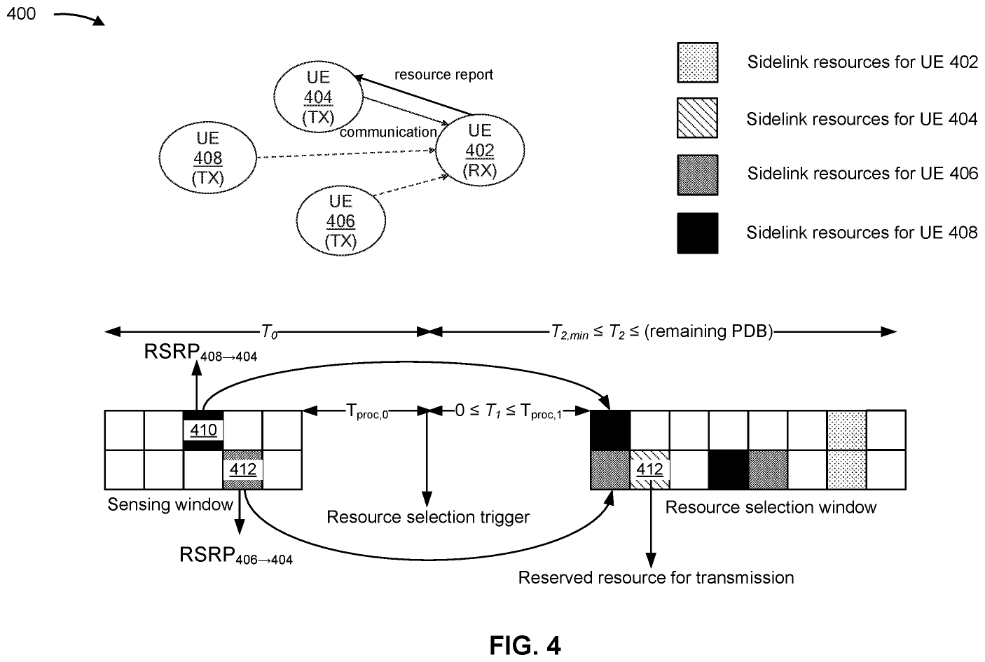

FIG. 4 is a diagram illustrating an example 400 of selecting sidelink resources, in accordance with the present disclosure. Example 400 shows a UE 402 (e.g., a UE 302) that may receive communications on a sidelink channel from other UEs (e.g., a UE 304), such as UE 404, UE 406, and/or UE 408.

As described in connection with FIGS. 4-7, UE 404 is a transmitting UE that is transmitting communications to UE 402, which is a receiving UE. UE 404 may use a resource report from UE 402, which may act as a reporting UE that reports available sidelink resources. Example 400 shows a resource report from UE 402 to UE 404 and a communication from UE 404 to UE 402.

If UE 404 is to transmit a communication to UE 402, UE 404 may sense the sidelink channel in a sensing window to determine which sidelink resources (e.g., subcarriers, subchannels) are available. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured per transmission priority and receive priority pair. UE 404 may measure DMRSs on a PSCCH or a PSSCH, according to a configuration.

For example, UE 404 may prepare to transmit a communication to UE 402. UE 404 may have already sensed previous sidelink resources and successfully decoded SCI from UE 406 and UE 408. UE 404 may try to reserve sidelink resources, and thus may check the availability of the future sidelink resources reserved by UE 406 and UE 408 by sensing the sidelink channel in the sensing window. UE 404 may measure an RSRP of a signal from UE 408 in sidelink resource 410, and an RSRP of a signal from UE 406 in sidelink resource 412. If an observed RSRP satisfies the RSRP threshold (e.g., is lower than a maximum RSRP), the corresponding sidelink resource may be available for reservations by UE 404. UE 404 may reserve the sidelink resource (which may be a random selection from available resources). For example, UE 404 may select and reserve sidelink resource 412 for transmission. This may be in a time slot after which UE 406 and UE 408 had used sidelink resources, and UE 404 may have sensed these sidelink resources earlier.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB). T₀, shown in FIG. 4, may be a configured value, such as 100 milliseconds (ms) or 1100 ms. T₁ may be a time duration that is specific to a UE's implementation. T_{2,min} may be configured per priority {1, 5, 10, 20} times 2^{μ}, where μ=0, 1, 2, and 3 for subcarrier spacing of 15 kilohertz (kHz), 30 kHz, 60 kHz, and 120 kHz, respectively.

If resource selection is triggered, a UE may use SCIs detected during the sensing window. If another UE is reserving a resource in the resource selection window, the UE may compare a measured RSRP from the other UE and compare it against the RSRP threshold given for the pair of priorities (pᵢ, pⱼ), where pᵢ is the priority of the packet for which the UE is reserving a resource, and pⱼ is the priority of the packet of the other UE. If the measured RSRP is below the threshold, then the resource is available.

UE 404 may be power-sensitive and thus may not afford to continually sense all of the sidelink resources. UE 402 may be more capable of sensing and reporting on the sidelink resources because, for example, UE 402 may be a smart phone while UE 402 may be a smart watch. UE 402 may receive unicast communications from UE 404, and UE 402 may report back available resources to UE 404. UE 402 may continually sense the sidelink resources and measure interference levels involving neighboring UEs. For example, UE 402 may measure an RSRP of a signal from neighboring UE 406 as −92 dBm and an RSRP of a signal from neighboring UE 408 as −102 dBm. For a signal of a last transmission of UE 404, UE 402 may measure a target signal level with an RSRP that was −90 dBm. UE 402 may estimate an SIR of a signal between UE 402 and UE 404 as −90 −(−92)=2 dB and an SIR between UE 404 and UE 408 as −90−(−102)=12 dB. If the SIR of a signal from UE 404 to UE 402 with interference from UE 408 is large enough (satisfies an availability threshold) for reliable communication between UE 402 and UE 404, UE 402 may mark a sidelink resource that was reserved by UE 408 as available for use for a communication from UE 404 to UE 402. This may be useful when UE 404 has more than one data stream with varying Quality of Service (QoS) requirements or transmissions with different MCS indices.

As indicated above, FIG. 4 is provided as an example. Other examples may differ from what is described with regard to FIG. 4.

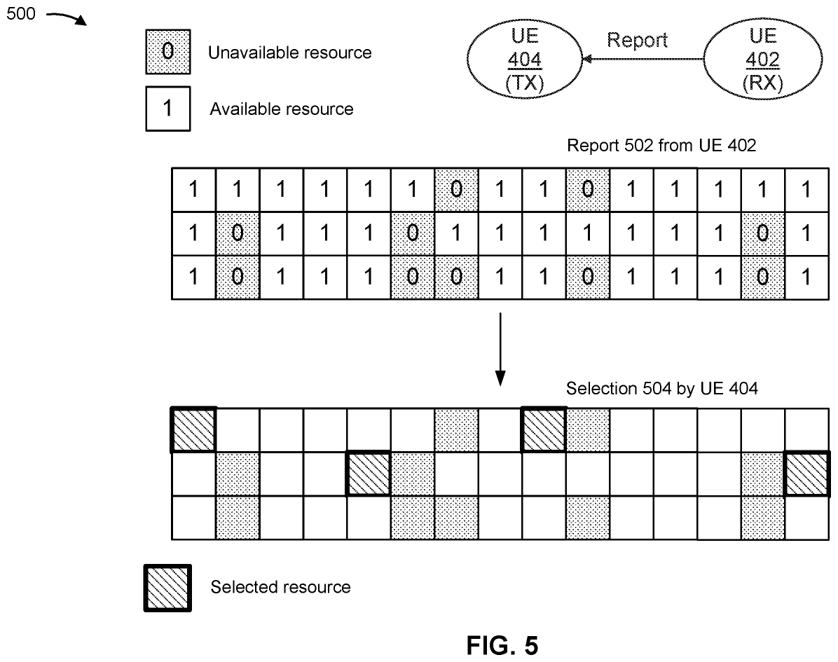

FIG. 5 is a diagram illustrating an example 500 of using a resource report for sidelink resources, in accordance with the present disclosure. Example 500 shows that UE 402 may transmit a report to UE 404.

UE 402 may transmit a report 502 indicating an availability of each sidelink resource. Rows in the report 502 may represent subcarriers or subchannels, and columns may represent time units (e.g., slots, symbols). The report 502 may be a binary report, such as a bitmap. For example, UE 402 may report a 1 bit for available and a 0 bit for unavailable. UE 404 may decode the report 502 and select (e.g., randomly) N resources from the available sidelink resources for potential N transmissions of a newly generated packet, or a packet of a transport block that has not been transmitted before. As shown by selection 504, UE 404 may select N=4 sidelink resources from the available sidelink resources indicated by the report 502. In some aspects, report 502 may indicate sidelink resources with conflicts. Such sidelink resources would not be preferred.

As indicated above, FIG. 5 is provided as an example. Other examples may differ from what is described with regard to FIG. 5.

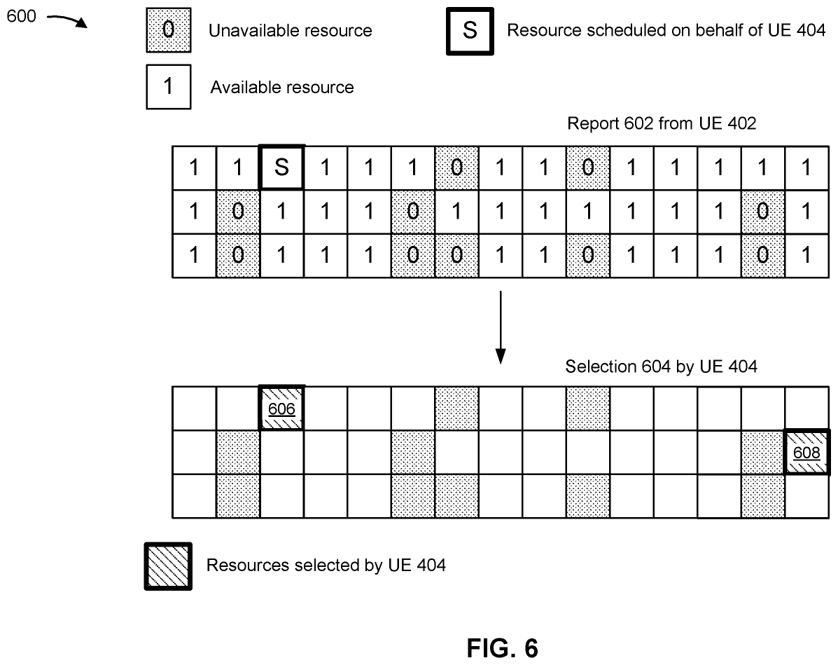

FIG. 6 is a diagram illustrating an example 600 of indicating and using scheduled sidelink resources, in accordance with the present disclosure.

UE 402 may prefer that UE 404 use sidelink resources with lower expected interference levels over other sidelink resources. If so, according to various aspects described herein, UE 402 may schedule one or more sidelink resources on behalf of UE 404 when indicating available sidelink resources to UE 404. UE 402 may still allow UE 404 to select other sidelink resources from the remaining available sidelink resources. By scheduling preferred sidelink resources for UE 404 that are available, UE 402 may cause UE 404 to conserve power, processing resources, and signaling resources because UE 404 performs less sensing and scheduling of sidelink resources. UE 404 may still have flexibility to sense the sidelink channel and select sidelink resources to avoid interference or collisions that degrade communications, which conserves power, processing resources, and signaling resources that would otherwise be wasted on failed transmissions and retransmissions.

For example, UE 404 may be configured to make a maximum of N transmissions for a packet or for a transport block. UE 402 may sense the channel and select a set of candidate sidelink resources in the resource selection window of UE 404 for the N transmissions. Within the set of candidate sidelink resources, UE 402 may select and schedule M scheduled sidelink resources, where M may be 0 or up to N of the candidate sidelink resources (0≤M≤N) of UE 404. Example 600 shows a report 602 from UE 402 indicating the set of candidate sidelink resources (resources marked with a “1”). The report 602 also indicates a scheduled sidelink resource (resource marked with “S”) that UE 402 has scheduled for UE 404 based at least in part on sensing the sidelink channel and detecting lower interference for the scheduled sidelink resource.

In some aspects, if M is less than N, UE 404 may select other sidelink resources from the set of candidate sidelink resources for any remaining transmissions up to N (N−M sidelink resources for N−M transmissions). As shown by selection 604, UE 404 may select the scheduled sidelink resource 606 for a first transmission and select another candidate sidelink resource 608 for a second transmission. If M=0, then report 602 may be similar to a report that is regularly transmitted.

In some aspects, UE 404 may sense the channel, and based at least in part on sensing the sidelink channel and measuring interference from the location of UE 404, may not use the scheduled candidate sidelink resource indicated in the report 602. Rather, UE 404 may select another candidate sidelink resource indicated as available in the report 602.

In some aspects, if M=N, UE 402 may indicate N scheduled sidelink resources by listing the respective indices of the N scheduled sidelink resources in the corresponding resource selection window of UE 404. UE 402 may send availability and/or conflict information in addition to the indices of the N scheduled sidelink resources. The additional availability and/or conflict information may include an indication of available candidate sidelink resources, which gives UE 404 flexibility to alter some selections from any scheduled sidelink resources indicated by UE 402. For example, if UE 404 senses the sidelink channel partially or fully, UE 404 may combine its own sensing results with the additional availability information from UE 402, in order to have a better picture of sidelink channel availability.

UE 404 may use the report 602 for an initial transmission of a transport block. For example, UE 404 may have received an indication of M=1 scheduled sidelink resource in the report 602 for an initial transmission of a transport block and a set of candidate sidelink resources in the form of a resource availability list or bitmap, as shown in FIG. 6. Then, UE 404 may make its initial transmission on the scheduled sidelink resource and have freedom to select from among the remaining candidate sidelink resources that are indicated as available in the report 602 from UE 402 to make remaining N−1 re-transmissions if needed.

The candidate sidelink resources and the scheduled sidelink resources may be considered preferred sidelink resources. Sidelink resources that may cause expected or potential resource conflicts may be considered non-preferred sidelink resources. These resource conflicts may include past and/or future resource conflicts that may occur in a time domain or in a time-frequency domain. In some aspects, there may be various inter-UE coordination schemes that UE 402 and UE 404 may use to indicate a type of inter-UE coordination message (e.g., indication of preferred sidelink resources, indication of non-preferred sidelink resources) or to otherwise indicate resource conflicts. For example, for a first scheme, UE 402 may indicate preferred sidelink resources to UE 404, and UE 404 may not sense sidelink resources. For the first scheme, UE 402 may effectively schedule transmissions for UE 404, and this may be used if UE 404 is power-sensitive. UE 404's transmissions could impact groupcast communications that are taking place around UE 404 and that are not visible to UE 402 when UE 402 is selecting resources. For a second scheme, UE 402 may indicate preferred sidelink resources to UE 404, and UE 404 may sense sidelink resources. Groupcast communications may be impacted less with the second scheme than with the first scheme. For a third scheme, UE 402 may indicate non-preferred sidelink resources to UE 404, and UE 404 may not sense sidelink resources. For a fourth scheme, UE 402 may indicate non-preferred sidelink resources to UE 404, and UE 404 may sense sidelink resources. For a fifth scheme, UE 402 may indicate non-preferred sidelink resources to other UEs.

According to some aspects described herein, an inter-UE coordination scheme may be configured for a resource pool or per resource pool. For example, the network or UE 402 may configure, by stored configuration information or by an indication, a resource pool to support inter-UE coordination for reporting preferred resources and/or non-preferred resources. The configured inter-UE coordination scheme may include the first scheme, the second scheme, the third scheme, the fourth scheme, the fifth scheme, or any combination thereof. In some aspects, a scheme may involve an indication of past and/or future resource conflicts that may occur in a time domain or in a time-frequency domain. By configuring an inter-UE coordination scheme per resource pool, the network or UE 402 may reduce conflicts and/or reduce power consumption of the UEs, while using conserving signaling resources.

Some inter-UE coordination schemes may be more useful for specific cast types (e.g., unicast, groupcast, broadcast) or may impact specific cast types negatively. Some inter-UE coordination schemes may be for resource pools that only support certain cast types. In some aspects, the network and/or UE 402 may configure UEs of a resource pool based at least in part on the case type supported by the UEs. For example, the first scheme may be supported in a resource pool that supports only unicast communication. After configuration, UE 402 may indicate information about preferred and/or non-preferred sidelink resources, and UE 404 may sense sidelink resources according to the inter-UE coordination scheme that is configured for an associated resource pool.

In some aspects, UE 404 may request or indicate a preferred inter-UE coordination scheme. For example, UE 404 may request a subset of schemes (e.g., the first scheme, the second scheme) that UE 404 may support. In other examples, if UE 404 is power limited, UE 404 may request the first scheme. The request may be dynamic or may be exchanged during a discovery phase via PC5 radio resource control (RRC) signaling.

As indicated above, FIG. 6 is provided as an example. Other examples may differ from what is described with regard to FIG. 6.

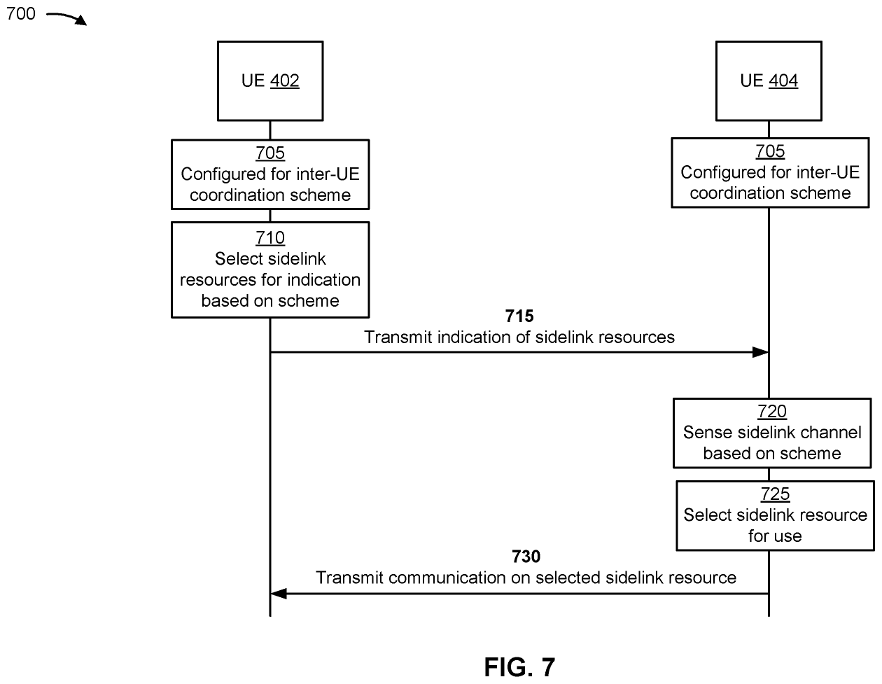

FIG. 7 is a diagram illustrating an example 700 of indicating and using sidelink resources, in accordance with the present disclosure. Example 700 shows that UE 402 and UE 404 may communicate with each other via one or more sidelink communications. In some aspects, UE 402 and/or UE 404 may communicate (e.g., transmit an uplink transmission and/or receive a downlink transmission) with a base station. UE 402, UE 404, and any base station may be part of a wireless network (e.g., wireless network 100). As described in connection with FIGS. 4-6, UE 404 is the reporting UE, and UE 402 is the UE transmitting a communication.

As shown by reference number 705, UE 402 and UE 404 may be configured for an inter-UE coordination scheme, as part of being associated with a resource pool. In some aspects, UE 404 may transmit an indication of a preferred inter-UE coordination scheme. The inter-UE coordination scheme may be specific to a cast type supported by the UEs in the resource pool. In some aspects, UE 402 and/or UE 404 may be configured to use an inter-UE coordination scheme by receiving an indication from the network (e.g., gNB). The indication may be received dynamically (e.g., via downlink control information (DCI)) or semi-statically (e.g., via RRC).

UEs associated with the resource pool may be configured with multiple inter-UE coordination schemes. If multiple schemes are supported in a resource pool, the inter-UE coordination schemes may be differentiated. For example, UE 402 and UE 404 may use orthogonal resources to send inter-UE coordination messages associated with different schemes. For different schemes, UE 402 and UE 404 may use different physical (PHY) channels (e.g., PSSCH vs. PSFCH) or different containers (e.g., SCI1, SCI2, medium access control control element (MAC-CE) or PC5-RRC) to differentiate schemes without an explicit differentiator. UE 402 may use some dedicated resources to transmit a PSSCH communication indicating preferred resources and a separate set of dedicated resources to transmit a PSSCH communication indicating non-preferred resources. UE 402 may indicate an inter-UE coordination scheme with a bit in SCI1 or SCI2. UE 402 may indicate an inter-UE coordination scheme via a MAC-CE, different SCI2 formats, and/or scrambling a cyclic redundancy check (CRC) of an SCI2 or a PSSCH communication.

In some aspects, UE 402 may configure UE 402, UE 404, and other UEs in the resource pool with an inter-UE coordination scheme based at least in part on a congestion level of traffic in the resource pool. For example, UE 402 may select the first scheme if a CBR for the resource pool satisfies a congestion threshold (e.g., maximum CBR) and select the second scheme if the CBR does not satisfy the congestion threshold.

In some aspects, UE 402 may configure UE 402, UE 404, and other UEs in the resource pool for an inter-UE coordination scheme based at least in part on whether periodic reservation is enabled for the resource pool. For example, UE 404 may have the same sidelink resources reserved periodically (e.g., every 10^{th} slot) as part of a periodic reservation for the resource pool, and UE 402 may configure UE 402 and UE 404 to use the first scheme and/or the second scheme only if this periodic reservation is enabled.

In some aspects, UE 402 may configure UE 402, UE 404, and other UEs in the resource pool for an inter-UE coordination scheme based at least in part on whether feedback is enabled. In some aspects, the inter-UE coordination scheme may be selected based at least in part on a type of feedback (e.g., acknowledgement (ACK)/negative acknowledgment (NACK) based feedback, NACK-only based feedback, ACK-only based feedback).

As shown by reference number 710, UE 402 may sense the sidelink channel and determine which sidelink resources are preferred (e.g., candidate sidelink resources, scheduled sidelink resources) and/or which sidelink resources are non-preferred (e.g., sidelink resource conflicts, sidelink resources with negative feedback). UE 402 may sense a sidelink channel in a sensing window for UE 404.

As shown by reference number 715, UE 402 may transmit, based at least in part on the inter-UE coordination scheme, an indication of the preferred and/or non-preferred sidelink resources via an RRC message, a MAC-CE, and/or sidelink control information (DCI). The indication from UE 402 may be in unicast transmissions to UE 404 or groupcast or broadcast transmissions to neighboring UEs, depending on a supportable cast type for the resource pool.

As shown by reference number 720, UE 404 may, based at least in part on the inter-UE coordination scheme, sense the sidelink channel for scheduled sidelink resources indicated by UE 402, other candidate sidelink resources indicated by UE 402, and/or any available sidelink resources indicated by other UEs, such as UE 406 or UE 408 shown in FIG. 4 (if groupcast is supported for the resource pool).

As shown by reference number 725, UE 404 may select sidelink resources from available sidelink resources indicated by UE 402. UE 404 may use a scheduled sidelink resource indicated by UE 402. For any remaining transmissions, UE 404 may select other candidate sidelink resources indicated by UE 402. UE 404 may take into account any reserved sidelink resources or available sidelink resources indicated by other UEs, such as UE 406 or UE 408. As shown by reference number 730, UE 404 may transmit a communication to UE 402 on a selected sidelink resource. UE 404 may transmit other communications to UE 402 with other selected sidelink resources.

As indicated above, FIG. 7 is provided as an example. Other examples may differ from what is described with regard to FIG. 7.

FIG. 8 is a diagram illustrating an example process 800 performed, for example, by a first UE, in accordance with the present disclosure. Example process 800 is an example where the UE (e.g., UE 120, UE 402) performs operations associated with inter-UE coordination for resource pools.

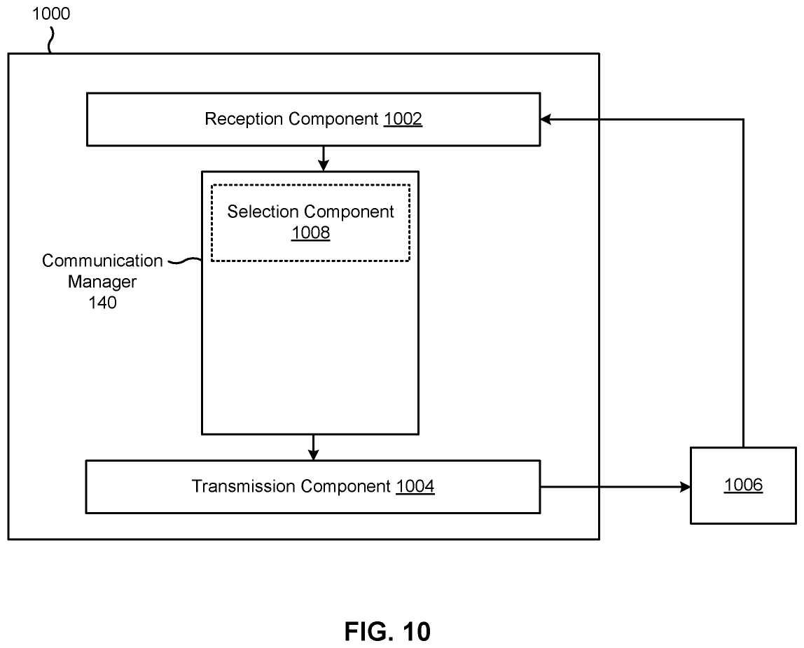

As shown in FIG. 8, in some aspects, process 800 may include selecting, from stored configuration information or a received indication, an inter-UE coordination scheme that is configured for a resource pool associated with the first UE (block 810). For example, the UE (e.g., using communication manager 140 and/or selection component 1008 depicted in FIG. 10) may select, from stored configuration information or a received indication, an inter-UE coordination scheme that is configured for a resource pool associated with the first UE, as described above.

As further shown in FIG. 8, in some aspects, process 800 may include transmitting, to a second UE, an indication of one or more of preferred sidelink resources or non-preferred sidelink resources for transmission from the second UE to the first UE, based at least in part on the inter-UE coordination scheme (block 820). For example, the UE (e.g., using communication manager 140 and/or transmission component 1004 depicted in FIG. 10) may transmit, to a second UE, an indication of one or more of preferred sidelink resources or non-preferred sidelink resources for transmission from the second UE to the first UE, based at least in part on the inter-UE coordination scheme, as described above.

Process 800 may include additional aspects, such as any single aspect or any combination of aspects described below and/or in connection with one or more other processes described elsewhere herein.

In a first aspect, the inter-UE coordination scheme is one of a first scheme in which the first UE indicates preferred sidelink resources to the second UE, where the second UE does not sense sidelink resources; a second scheme in which the first UE indicates preferred sidelink resources to the second UE, where the second UE senses sidelink resources; a third scheme in which the first UE indicates non-preferred sidelink resources to the second UE, where the second UE does not sense sidelink resources; a fourth scheme in which the first UE indicates non-preferred sidelink resources to the second UE, where the second UE senses sidelink resources; and a fifth scheme in which the first UE indicates non-preferred sidelink resources to other UEs.

In a second aspect, alone or in combination with the first aspect, the selecting includes selecting the inter-UE coordination scheme based at least in part on whether the resource pool supports unicast, groupcast, or broadcast.

In a third aspect, alone or in combination with one or more of the first and second aspects, the received indication includes an inter-UE coordination scheme preferred by the second UE.

In a fourth aspect, alone or in combination with one or more of the first through third aspects, the selecting includes selecting the inter-UE coordination scheme based at least in part on a level of congestion in the resource pool.

In a fifth aspect, alone or in combination with one or more of the first through fourth aspects, the selecting includes selecting the inter-UE coordination scheme based at least in part on whether periodic reservation is enabled for the resource pool.

In a sixth aspect, alone or in combination with one or more of the first through fifth aspects, the selecting includes selecting the inter-UE coordination scheme based at least in part on whether feedback is enabled for the resource pool.

In a seventh aspect, alone or in combination with one or more of the first through sixth aspects, the selecting includes selecting the inter-UE coordination scheme based at least in part on a type of feedback.

In an eighth aspect, alone or in combination with one or more of the first through seventh aspects, the indication of the one or more of preferred sidelink resources or non-preferred sidelink resources indicates one or more of a type of inter-UE coordination message or a resource conflict.

In a ninth aspect, alone or in combination with one or more of the first through eighth aspects, the inter-UE coordination scheme is one of a first inter-UE coordination scheme and a second inter-UE coordination scheme configured for the resource pool, and the transmitting includes transmitting an indication of preferred sidelink resources or non-preferred sidelink resources according to the first inter-UE coordination scheme on a first set of resources, and transmitting an indication of preferred sidelink resources or non-preferred sidelink resources according to the second inter-UE coordination scheme on a second set of resources.

In a tenth aspect, alone or in combination with one or more of the first through ninth aspects, process 800 includes indicating, to the second UE, the inter-UE coordination scheme selected for the resource pool in SCI.

In an eleventh aspect, alone or in combination with one or more of the first through tenth aspects, process 800 includes indicating, to the second UE, the inter-UE coordination scheme selected for the resource pool in a MAC-CE.

In a twelfth aspect, alone or in combination with one or more of the first through eleventh aspects, process 800 includes indicating, to the second UE, the inter-UE coordination scheme selected for the resource pool by an SCI format.

In a thirteenth aspect, alone or in combination with one or more of the first through twelfth aspects, process 800 includes indicating, to the second UE, the inter-UE coordination scheme selected for the resource pool by how a CRC for a message is scrambled, which physical channel is used, and/or which container is used.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a first UE, in accordance with the present disclosure. Example process 900 is an example where the first UE (e.g., UE 120, UE 404) performs operations associated with inter-UE coordination for resource pools. Note that the first UE of FIG. 9 may be the second UE described for FIG. 8. That is, FIG. 9 is a change of viewpoint from FIG. 8.

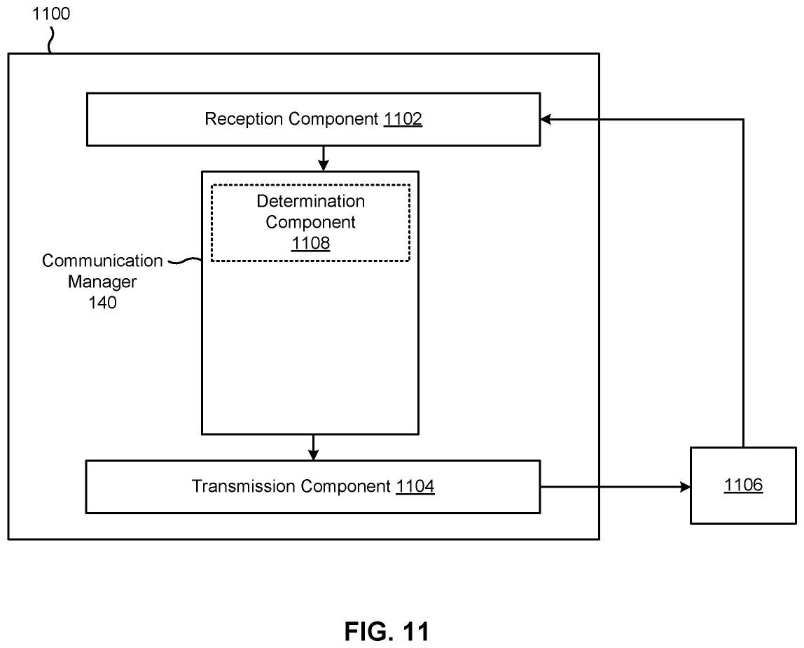

As shown in FIG. 9, in some aspects, process 900 may include receiving, from a second UE according to an inter-UE coordination scheme configured for a resource pool associated with the first UE, an indication of one or more of preferred sidelink resources or non-preferred sidelink resources for transmission to the second UE (block 910). For example, the UE (e.g., using communication manager 140 and/or reception component 1102 depicted in FIG. 11) may receive, from a second UE according to an inter-UE coordination scheme configured for a resource pool associated with the first UE, an indication of one or more of preferred sidelink resources or non-preferred sidelink resources for transmission to the second UE, as described above.

As further shown in FIG. 9, in some aspects, process 900 may include sensing sidelink resources if the inter-UE coordination scheme specifies that the first UE is to perform sensing (block 920). For example, the UE (e.g., using communication manager 140 and/or reception component 1102 depicted in FIG. 11) may sense sidelink resources if the inter-UE coordination scheme specifies that the first UE is to perform sensing, as described above.

As further shown in FIG. 9, in some aspects, process 900 may include transmitting a communication on a sidelink channel to the second UE based at least in part on the indication of the one or more of preferred sidelink resources or non-preferred sidelink resources and a result of the sensing if sensing is performed (block 930). For example, the UE (e.g., using communication manager 140 and/or transmission component 1104 depicted in FIG. 11) may transmit a communication on a sidelink channel to the second UE based at least in part on the indication of the one or more of preferred sidelink resources or non-preferred sidelink resources and a result of the sensing if sensing is performed, as described above.

Process 900 may include additional aspects, such as any single aspect or any combination of aspects described below and/or in connection with one or more other processes described elsewhere herein.

In a first aspect, the inter-UE coordination scheme is one of a first scheme for the second UE to indicate preferred sidelink resources to the first UE, where the second UE does not sense sidelink resources; a second scheme for the second UE to indicate preferred sidelink resources to the first UE, where the second UE senses sidelink resources; a third scheme for the second UE to indicate non-preferred sidelink resources to the first UE, where the second UE does not sense sidelink resources; a fourth scheme for the second UE to indicate non-preferred sidelink resources to the first UE, where the second UE senses sidelink resources; and a fifth scheme in which the first UE indicates non-preferred sidelink resources to other UEs.

In a second aspect, alone or in combination with the first aspect, process 900 includes transmitting, to the second UE, a preferred inter-UE coordination scheme.

In a third aspect, alone or in combination with one or more of the first and second aspects, the indication of the one or more of preferred sidelink resources or non-preferred sidelink resources indicates one or more of a type of inter-UE coordination message or a resource conflict.

In a fourth aspect, alone or in combination with one or more of the first through third aspects, the inter-UE coordination scheme is one of a first inter-UE coordination scheme and a second inter-UE coordination scheme configured for the resource pool, and the receiving includes receiving preferred sidelink resources or non-preferred sidelink resources according to the first inter-UE coordination scheme on a first set of resources, and receiving preferred sidelink resources or non-preferred sidelink resources according to the second inter-UE coordination scheme on a second set of resources.

In a fifth aspect, alone or in combination with one or more of the first through fourth aspects, process 900 includes receiving an indication of the inter-UE coordination scheme selected for the resource pool in sidelink control information.

In a sixth aspect, alone or in combination with one or more of the first through fifth aspects, process 900 includes receiving an indication of the inter-UE coordination scheme selected for the resource pool in a MAC-CE.

In a seventh aspect, alone or in combination with one or more of the first through sixth aspects, process 900 includes determining the inter-UE coordination scheme selected for the resource pool based at least in part on a format of SCI.

In an eighth aspect, alone or in combination with one or more of the first through seventh aspects, process 900 includes determining the inter-UE coordination scheme selected for the resource pool based at least in part on how a CRC for a message is scrambled, which physical channel is used, and/or which container is used.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a first UE (e.g., UE 120, UE 402), or a first UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a selection component 1008, among other examples.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the first UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a demodulator, a MIMO detector, a receive processor, a controller/processor, a memory, or a combination thereof, of the first UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the first UE described in connection with FIG. 2. In some aspects, the transmission component 1004 may be co-located with the reception component 1002 in a transceiver.

The selection component 1008 may select, from stored configuration information or a received indication, an inter-UE coordination scheme that is configured for a resource pool associated with the first UE. The transmission component 1004 may transmit, to a second UE, an indication of one or more of preferred sidelink resources or non-preferred sidelink resources for transmission from the second UE to the first UE, based at least in part on the inter-UE coordination scheme.

The transmission component 1004 may indicate, to the second UE, the inter-UE coordination scheme selected for the resource pool in SCI. The transmission component 1004 may indicate, to the second UE, the inter-UE coordination scheme selected for the resource pool in a MAC-CE. The transmission component 1004 may indicate, to the second UE, the inter-UE coordination scheme selected for the resource pool by an SCI format. The transmission component 1004 may indicate, to the second UE, the inter-UE coordination scheme selected for the resource pool by how a CRC for a message is scrambled, which physical channel is used, and/or which container is used.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a block diagram of an example apparatus 1100 for wireless communication. The apparatus 1100 may be a first UE (e.g., UE 120, UE 404), or a first UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include determination component 1108, among other examples.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the first UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a demodulator, a MIMO detector, a receive processor, a controller/processor, a memory, or a combination thereof, of the first UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the first UE described in connection with FIG. 2. In some aspects, the transmission component 1104 may be co-located with the reception component 1102 in a transceiver.

The reception component 1102 may receive, from a second UE according to an inter-UE coordination scheme configured for a resource pool associated with the first UE, an indication of one or more of preferred sidelink resources or non-preferred sidelink resources for transmission to the second UE. The reception component 1102 may sense sidelink resources if the inter-UE coordination scheme specifies that the first UE is to perform sensing. The transmission component 1104 may transmit a communication on a sidelink channel to the second UE based at least in part on the indication of the one or more of preferred sidelink resources or non-preferred sidelink resources and a result of the sensing if sensing is performed.

The transmission component 1104 may transmit, to the second UE, a preferred inter-UE coordination scheme. The reception component 1102 may receive an indication of the inter-UE coordination scheme selected for the resource pool in SCI. The reception component 1102 may receive an indication of the inter-UE coordination scheme selected for the resource pool in a MAC-CE.

The determination component 1108 may determine the inter-UE coordination scheme selected for the resource pool based at least in part on a format of SCI.

The determination component 1108 may determine the inter-UE coordination scheme selected for the resource pool based at least in part on how a CRC for a message is scrambled, which physical channel is used, and/or which container is used.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a first user equipment (UE), comprising: selecting, from stored configuration information or a received indication, an inter-UE coordination scheme that is configured for a resource pool associated with the first UE; and transmitting, to a second UE, an indication of one or more of preferred sidelink resources or non-preferred sidelink resources for transmission from the second UE to the first UE, based at least in part on the inter-UE coordination scheme.

Aspect 2: The method of Aspect 1, wherein the inter-UE coordination scheme is one of: a first scheme in which the first UE indicates preferred sidelink resources to the second UE, wherein the second UE does not sense sidelink resources; a second scheme in which the first UE indicates preferred sidelink resources to the second UE, wherein the second UE senses sidelink resources; a third scheme in which the first UE indicates non-preferred sidelink resources to the second UE, wherein the second UE does not sense sidelink resources; a fourth scheme in which the first UE indicates non-preferred sidelink resources to the second UE, wherein the second UE senses sidelink resources; and a fifth scheme in which the first UE indicates non-preferred sidelink resources to other UEs.

Aspect 3: The method of Aspect 1 or 2, wherein the selecting includes selecting the inter-UE coordination scheme based at least in part on whether the resource pool supports unicast, groupcast, or broadcast.

Aspect 4: The method of any of Aspects 1-3, wherein the received indication includes an inter-UE coordination scheme preferred by the second UE.

Aspect 5: The method of any of Aspects 1-4, wherein the selecting includes selecting the inter-UE coordination scheme based at least in part on a level of congestion in the resource pool.

Aspect 6: The method of any of Aspects 1-5, wherein the selecting includes selecting the inter-UE coordination scheme based at least in part on whether periodic reservation is enabled for the resource pool.

Aspect 7: The method of any of Aspects 1-6, wherein the selecting includes selecting the inter-UE coordination scheme based at least in part on whether feedback is enabled for the resource pool.

Aspect 8: The method of any of Aspects 1-7, wherein the selecting includes selecting the inter-UE coordination scheme based at least in part on a type of feedback.

Aspect 9: The method of any of Aspects 1-8, wherein the indication of the one or more of preferred sidelink resources or non-preferred sidelink resources indicates one or more of a type of inter-UE coordination message or a resource conflict.

Aspect 10: The method of any of Aspects 1-9, wherein the inter-UE coordination scheme is one of a first inter-UE coordination scheme and a second inter-UE coordination scheme configured for the resource pool, and wherein the transmitting includes: transmitting an indication of preferred sidelink resources or non-preferred sidelink resources according to the first inter-UE coordination scheme on a first set of resources; and transmitting an indication of preferred sidelink resources or non-preferred sidelink resources according to the second inter-UE coordination scheme on a second set of resources.

Aspect 11: The method of any of Aspects 1-10, further comprising indicating, to the second UE, the inter-UE coordination scheme selected for the resource pool in sidelink control information.

Aspect 12: The method of any of Aspects 1-11, further comprising indicating, to the second UE, the inter-UE coordination scheme selected for the resource pool in a medium access control control element (MAC-CE).

Aspect 13: The method of any of Aspects 1-12, further comprising indicating, to the second UE, the inter-UE coordination scheme selected for the resource pool by a sidelink control information format.

Aspect 14: The method of any of Aspects 1-13, further comprising indicating, to the second UE, the inter-UE coordination scheme selected for the resource pool by one or more of how a cyclic redundancy check for a message is scrambled, which physical channel is used, or which container is used.

Aspect 15: A method of wireless communication performed by a first user equipment (UE), comprising: receiving, from a second UE according to an inter-UE coordination scheme configured for a resource pool associated with the first UE, an indication of one or more of preferred sidelink resources or non-preferred sidelink resources for transmission to the second UE; sensing sidelink resources if the inter-UE coordination scheme specifies that the first UE is to perform sensing; and transmitting a communication on a sidelink channel to the second UE based at least in part on the indication of the one or more of preferred sidelink resources or non-preferred sidelink resources and a result of the sensing if sensing is performed.

Aspect 16: The method of Aspect 15, wherein the inter-UE coordination scheme is one of: a first scheme for the second UE to indicate preferred sidelink resources to the first UE, wherein the second UE does not sense sidelink resources; a second scheme for the second UE to indicate preferred sidelink resources to the first UE, wherein the second UE senses sidelink resources; a third scheme for the second UE to indicate non-preferred sidelink resources to the first UE, wherein the second UE does not sense sidelink resources; a fourth scheme for the second UE to indicate non-preferred sidelink resources to the first UE, wherein the second UE senses sidelink resources; and a fifth scheme in which the first UE indicates non-preferred sidelink resources to other UEs.

Aspect 17: The method of Aspect 15 or 16, further comprising transmitting, to the second UE, a preferred inter-UE coordination scheme.

Aspect 18: The method of any of Aspects 15-17, wherein the indication of the one or more of preferred sidelink resources or non-preferred sidelink resources indicates one or more of a type of inter-UE coordination message or a resource conflict.

Aspect 19: The method of any of Aspects 15-18, wherein the inter-UE coordination scheme is one of a first inter-UE coordination scheme and a second inter-UE coordination scheme configured for the resource pool, and wherein the receiving includes: receiving preferred sidelink resources or non-preferred sidelink resources according to the first inter-UE coordination scheme on a first set of resources; and receiving preferred sidelink resources or non-preferred sidelink resources according to the second inter-UE coordination scheme on a second set of resources.

Aspect 20: The method of any of Aspects 15-19, further comprising receiving an indication of the inter-UE coordination scheme selected for the resource pool in sidelink control information.

Aspect 21: The method of Aspect any of Aspects 15-20, further comprising receiving an indication of the inter-UE coordination scheme selected for the resource pool in a medium access control control element (MAC-CE).

Aspect 22: The method of any of Aspects 15-21, further comprising determining the inter-UE coordination scheme selected for the resource pool based at least in part on a format of sidelink control information.

Aspect 23: The method of any of Aspects 15-22, further comprising determining the inter-UE coordination scheme selected for the resource pool based at least in part on one or more of how a cyclic redundancy check for a message is scrambled which physical channel is used, or which container is used.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising a memory and one or more processors coupled to the memory, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
select, from stored configuration information or a received indication, an inter-UE coordination scheme that is configured for a resource pool associated with the first UE; and
transmit, to a second UE, an indication of one or more of preferred sidelink resources or non-preferred sidelink resources for transmission from the second UE to the first UE, based at least in part on the inter-UE coordination scheme.

2. The first UE of claim 1, wherein the inter-UE coordination scheme is one of:
a first scheme in which the first UE indicates preferred sidelink resources to the second UE, wherein the second UE does not sense sidelink resources;
a second scheme in which the first UE indicates preferred sidelink resources to the second UE, wherein the second UE senses sidelink resources;
a third scheme in which the first UE indicates non-preferred sidelink resources to the second UE, wherein the second UE does not sense sidelink resources;
a fourth scheme in which the first UE indicates non-preferred sidelink resources to the second UE, wherein the second UE senses sidelink resources; and
a fifth scheme in which the first UE indicates non-preferred sidelink resources to other UEs.

3. The first UE of claim 1, wherein the one or more processors are configured to select the inter-UE coordination scheme based at least in part on whether the resource pool supports unicast, groupcast, or broadcast.

4. The first UE of claim 1, wherein the received indication includes an inter-UE coordination scheme preferred by the second UE.

5. The first UE of claim 1, wherein the one or more processors are configured to select the inter-UE coordination scheme based at least in part on a level of congestion in the resource pool.

6. The first UE of claim 1, wherein the one or more processors are configured to select the inter-UE coordination scheme based at least in part on whether periodic reservation is enabled for the resource pool.

7. The first UE of claim 1, wherein the one or more processors are configured to select the inter-UE coordination scheme based at least in part on whether feedback is enabled for the resource pool.

8. The first UE of claim 1, wherein the one or more processors are configured to select the inter-UE coordination scheme based at least in part on a type of feedback.

9. The first UE of claim 1, wherein the indication of the one or more of preferred sidelink resources or non-preferred sidelink resources indicates one or more of a type of inter-UE coordination message or a resource conflict.

10. The first UE of claim 1, wherein the inter-UE coordination scheme is one of a first inter-UE coordination scheme and a second inter-UE coordination scheme configured for the resource pool, and wherein the one or more processors are configured to:
transmit an indication of preferred sidelink resources or non-preferred sidelink resources according to the first inter-UE coordination scheme on a first set of resources; and
transmit an indication of preferred sidelink resources or non-preferred sidelink resources according to the second inter-UE coordination scheme on a second set of resources.

11. The first UE of claim 1, wherein the one or more processors are configured to indicate, to the second UE, the inter-UE coordination scheme selected for the resource pool in sidelink control information.

12. The first UE of claim 1, wherein the one or more processors are configured to indicate, to the second UE, the inter-UE coordination scheme selected for the resource pool in a medium access control control element (MAC-CE).

13. The first UE of claim 1, wherein the one or more processors are configured to indicate, to the second UE, the inter-UE coordination scheme selected for the resource pool by a sidelink control information format.

14. The first UE of claim 1, wherein the one or more processors are configured to indicate, to the second UE, the inter-UE coordination scheme selected for the resource pool by one or more of how a cyclic redundancy check for a message is scrambled, which physical channel is used, or which container is used.

15. A first user equipment (UE) for wireless communication, comprising:
a memory; and
one or more processors, coupled to the memory, configured to:
receive, from a second UE according to an inter-UE coordination scheme configured for a resource pool associated with the first UE, an indication of one or more of preferred sidelink resources or non-preferred sidelink resources for transmission to the second UE;
sense sidelink resources if the inter-UE coordination scheme specifies that the first UE is to perform sensing; and
transmit a communication on a sidelink channel to the second UE based at least in part on the indication of the one or more of preferred sidelink resources or non-preferred sidelink resources and a result of the sensing if sensing is performed.

16. The first UE of claim 15, wherein the one or more processors are configured to transmit, to the second UE, a preferred inter-UE coordination scheme.

17. The first UE of claim 15, wherein the inter-UE coordination scheme is one of a first inter-UE coordination scheme and a second inter-UE coordination scheme configured for the resource pool, and wherein the one or more processors are configured to:
receive preferred sidelink resources or non-preferred sidelink resources according to the first inter-UE coordination scheme on a first set of resources; and
receive preferred sidelink resources or non-preferred sidelink resources according to the second inter-UE coordination scheme on a second set of resources.

18. The first UE of claim 15, wherein the one or more processors are configured to receive an indication of the inter-UE coordination scheme selected for the resource pool in sidelink control information.

19. The first UE of claim 15, wherein the one or more processors are configured to determine the inter-UE coordination scheme selected for the resource pool based at least in part on a format of sidelink control information.

20. The first UE of claim 15, wherein the one or more processors are configured to determine the inter-UE coordination scheme selected for the resource pool based at least in part on one or more of how a cyclic redundancy check for a message is scrambled, which physical channel is used, or which container is used.

21. A method of wireless communication performed by a first user equipment (UE), comprising:
selecting, from stored configuration information or a received indication, an inter-UE coordination scheme that is configured for a resource pool associated with the first UE; and
transmitting, to a second UE, an indication of one or more of preferred sidelink resources or non-preferred sidelink resources for transmission from the second UE to the first UE, based at least in part on the inter-UE coordination scheme.

22. The method of claim 21, wherein the selecting includes selecting the inter-UE coordination scheme based at least in part on whether the resource pool supports unicast, groupcast, or broadcast.

23. The method of claim 21, wherein the received indication includes an inter-UE coordination scheme preferred by the second UE.

24. The method of claim 21, wherein the selecting includes selecting the inter-UE coordination scheme based at least in part on whether feedback is enabled for the resource pool.

25. The method of claim 21, wherein the inter-UE coordination scheme is one of a first inter-UE coordination scheme and a second inter-UE coordination scheme configured for the resource pool, and wherein the transmitting includes:
transmitting an indication of preferred sidelink resources or non-preferred sidelink resources according to the first inter-UE coordination scheme on a first set of resources; and
transmitting an indication of preferred sidelink resources or non-preferred sidelink resources according to the second inter-UE coordination scheme on a second set of resources.

26. The method of claim 21, further comprising indicating, to the second UE, the inter-UE coordination scheme selected for the resource pool in sidelink control information.

27. The method of claim 21, further comprising indicating, to the second UE, the inter-UE coordination scheme selected for the resource pool by a sidelink control information format.

28. The method of claim 21, further comprising indicating, to the second UE, the inter-UE coordination scheme selected for the resource pool by one or more of how a cyclic redundancy check for a message is scrambled, which physical channel is used, or which container is used.

29. A method of wireless communication performed by a first user equipment (UE), comprising:
receiving, from a second UE according to an inter-UE coordination scheme configured for a resource pool associated with the first UE, an indication of one or more of preferred sidelink resources or non-preferred sidelink resources for transmission to the second UE;
sensing sidelink resources if the inter-UE coordination scheme specifies that the first UE is to perform sensing; and
transmitting a communication on a sidelink channel to the second UE based at least in part on the indication of the one or more of preferred sidelink resources or non-preferred sidelink resources and a result of the sensing if sensing is performed.

30. The method of claim 29, further comprising transmitting, to the second UE, a preferred inter-UE coordination scheme.
